(19) United States
(12) Patent Application Publication
(10) Pub. No.: US 2024/0317486 A1
(43) Pub. Date: Sep. 26, 2024

(54) BEVERAGE OR FOODSTUFF PREPARATION SYSTEM

(71) Applicant: SOCIETE DES PRODUITS NESTLE S.A., Vevey (CH)

(72) Inventors: ALFRED YOAKIM, St-Legier-La Chiesaz (CH); PETER SIEGRIST, Jegenstorf (CH); STEFAN KAESER, Aarau (CH)

(21) Appl. No.: 18/579,099

(22) PCT Filed: Jul. 11, 2022
(86) PCT No.: PCT/EP2022/069316

§ 371 Date: Jan. 12, 2024

(30) Foreign Application Priority Data
Jul. 16, 2021 (EP) 21186146.3

(51) Int. Cl. B65D 85/804; A47J 31/44

(52) U.S. Cl. CPC B65D 85/8058; A47J 31/4492

(57) ABSTRACT

A container arranged for containing a precursor material for use with a machine for preparing a beverage and/or foodstuff, the container comprising: a storage portion a closing member, a flange connecting the storage portion and closing member, a machine-readable code storing preparation information for use with a preparation process performed by said machine, the code comprising a plurality of elements: wherein said elements of the code extend from a first position on the storage portion to a second position on the flange, so that the code is readable from the flange or the storage portion, the elements arranged to be read about an axis of rotation of the capsule.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine, and; the preparation information is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

Various codes have been developed, an example of which is provided in EP 2594171 A1, wherein a lower side of a flange of a capsule comprises a code arranged thereon. A drawback of such a code is that it can only be read from a limited number of positions, which can impose restrictions on machine design.

Therefore, in spite of the effort already invested in the development of said systems further improvements are desirable.

### SUMMARY

The present disclosure provides a container for containing a precursor material for use with a machine for preparing a beverage or foodstuff or a precursor thereof, the container including a machine-readable code storing preparation information for use with a preparation process performed by said machine, in which the machine is controlled based on the preparation information to prepare the beverage and/or foodstuff or precursor thereof.

In embodiments, the container includes: a storage portion, for storage of precursor material; a dosing member (e.g. a membrane) for dosing the storage portion, and; a flange connecting the storage portion and dosing member.

Examples of suitable closing members can be derived from the teachings disclosed herein and examples relating to the containers and/or closing members. Suitable constructional and/or operational details are for instance disclosed in EP2569230.

In embodiments, the code comprises a plurality of elements, the elements encoding a data portion storing the preparation information, and encoding a finder sequence for locating the data portion.

In embodiments, the elements (e.g. some or all the elements forming the code) extend from a first position on the storage portion to a second position on the flange, so that the code is readable (e.g. entirely readable, so that all information of the code encoded at said position) from the flange or the storage portion, the elements arranged to be read about an axis of rotation of the container.

By implementing the elements that form the code to be arranged on both the flange and the storage portion, and to extend (including continuously without gaps) between the first and second positions, whilst being readable about a rotational axis of symmetry, the code may conveniently be read from a range of positions, e.g. older machines may read the code from a lower side of the flange and newer machines may read the code from the side of the storage portion. Hence the code may be compatible with a range of machines.

In embodiments, the container is rotationally symmetric about the axis of rotation and the code is arranged centrally along a virtual circular line that has a centre at the axis of rotation. By centring the code about the axis of rotation it may be conveniently read.

In embodiments, the first position is at a base region of a cavity of the storage portion.

As used herein the term “base region” may refer to a region of greatest depth of the cavity of the storage portion, wherein the depth direction extends from the flange. The base region may be defined, particularly for hemispherical containers, as any region with a depth greater than 70% or 80% or 90% of the maximum depth. The base region may have a centre which faces (including substantially faces) in the axial direction, which may be at a rotational axis of symmetry.

In embodiments, the first position is at (including directly at or proximal with a small gap away from) an axis of rotation of the container. By arranging the first position at the axis of rotation, elements of the code to extend up to and converge to a common point at the axis of rotation, the code may also be read proximal the axis of rotation.

In embodiments, the second position is proximal or at an outer rim of the flange. By arranging the code to extend up to or over a rim of the flange the code may be read on the underside of the flange or the rim of the flange.

In embodiments, the code elements extend with a centre line aligned to a radial direction from the first position to the second position. By implementing the code to extend outwardly from the rotational axis in a direction that its aligned radially, it may be ensured that the code can be read at a range of positions. As used herein the term “centre line” may refer to a line that extends along a code element through a mid-distance of the circumferential extent of the element.

In embodiments, the code elements extend with increasing circumferential width with radial distance. By arranging the code elements to increase in circumferential width (e.g. a minor dimension, wherein the major dimension is aligned to the radial direction) the further away from the axis of rotation, it may be ensured that the same information is accurately encoded independent of where the code is read from. In embodiments, the code elements may increase in circumferential width proportionally with radial distance, so that their relative circumferential proportion does not change with radial distance. By relative circumferential proportion, it is meant a ratio of circumferential width and total circumference at where said width is measured.

In embodiments, the code elements extend continuously between the first and second positions. By arranging the elements to extend continuously, e.g. with no separation or bisection by features of the container, the code may be read at any position between the first and second positions.

In embodiments, the elements (e.g. some or all the elements forming the code) extend on the storage portion from a first position to a second position, the first position at a base region of the storage portion (including at a centre, which can include directly or proximate the center, of the storage portion, which may be aligned to a rotational axis of symmetry) the second position at the flange (including directly at the junction between the flange and storage portion, or proximal thereto), the elements arranged to be read about an axis of rotation of the container. In embodiments, the second position on the storage portion at the flange comprises the storage portion arranged to face a radial direction, e.g. the storage portion intersects the flange portion at (including substantially at) 90 degrees to a plane of the flange, which is defined by the lateral and longitudinal directions and may be in the radial direction.

By implementing the elements that form the code to be arranged over a substantial portion of the storage portion between said first and second positions, and to extend (including continuously without gaps) between said positions, whilst being readable about a rotational axis of symmetry, the code may conveniently be read from a range of positions, e.g. older machines may read the code from a lower position of the storage portion and newer machines may read the code from the upper position of the storage portion. Hence the code may be compatible with a range of machines. Moreover, the code may be read aligned to the rotational axis of symmetry or at 90 (at the base of the storage portion) or at 90 degrees thereto (at the intersection with the flange).

In embodiments, the elements are arranged on a circumferentially extending virtual line. By arranging said elements to be intersected by a virtual line, they can be read as a code reader is rotated relative said line.

The present disclosure provides a substrate for attachment to a container for containing a precursor material for use with a machine for preparing a beverage and/or foodstuff or a precursor thereof, the substrate comprising a code comprising any feature of the code of the preceding embodiments or another embodiment disclosed herein.

As used herein the term “substrate” may refer to any suitable carrier for the code that can be used to connect the code to a container, examples of which include: a sticker; a cardboard member to receive an adhesive strip, and; other suitable arrangements.

The present disclosure provides a system comprising the container of any preceding embodiment or another embodiment disclosed herein and a machine for preparing a beverage and/or foodstuff or a precursor thereof.

In embodiments, the machine includes: a code reading system to read the code of the container; a processing unit for processing the precursor material of the container, and; electrical circuitry to control the processing unit based on preparation information read from the code. In embodiments, the processing unit includes a container processing unit and a fluid processing system, and; the electrical circuitry is arranged to control the container processing unit and fluid processing system based on the preparation information read from the code. In embodiments, the processing unit is arranged as a loose material processing unit, and; the electrical circuitry is arranged to control the loose material processing unit to process loose precursor material dispensed from the container or arranged in the container based on the preparation information read from the code.

In embodiments, the code reading system is arranged to read the code as the container is rotated about an axis of rotation, and the processing unit is arranged to process the precursor material as the container is rotated about said axis of rotation. Code reading and precursor material processing may be executed concurrently or consecutively.

The present disclosure provides use of the container of any preceding embodiment or another embodiment disclosed herein for a machine for preparing a beverage and/or foodstuff or a precursor thereof.

The present disclosure provides a method of reading preparation information for use in a preparation process, in which a machine is controlled based on the preparation information to prepare a beverage and/or foodstuff or precursor thereof, the method comprising: reading preparation information from a code of a container any preceding embodiment or another embodiment disclosed herein. The method may include reading the code from the first position and/or second position on the container, e.g. with a code reader that is suitably angled for one of said positions.

The method may be implemented as part of a method of preparing a beverage or foodstuff or a precursor thereof, in which a processing unit is controlled based on the preparation information to execute a preparation process on the precursor material.

The method may implement the features of any preceding embodiment, or another embodiment disclosed herein.

The present disclosure provides electrical circuitry to implement the method of the preceding embodiment or another embodiment disclosed herein.

The present disclosure provides a computer readable medium comprising program code to implement the method of the preceding embodiment or another embodiment disclosed herein.

The present disclosure provides a method of encoding preparation information with a code, the method comprising: arranging elements of the code to extend from a first position on a storage portion of a container to a second position on the flange of the container, so that the code is readable from the flange or the storage portion, the elements arranged to be read about an axis of rotation of the container.

The present disclosure provides a method of encoding preparation information with a code, the method comprising: arranging elements of the code to extend from a first position on a storage portion of a container to a second position on the storage portion of the container, wherein the first position is at a base region of the storage portion the second position on the storage portion proximal the flange, the elements arranged to be read about an axis of rotation of the container.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B and 5 are illustrative diagrams showing an embodiment container processing system of the machine of FIG. 2.

FIG. 6 is an illustrative diagram showing an embodiment machine of FIG. 2, which comprises a loose material processing unit.

FIG. 7 is a block diagram showing embodiment control electrical circuitry of the machine of FIG. 2.

FIG. 8 is an illustrative diagram showing embodiment container of the system of FIG. 1.

FIG. 9 is flow diagram showing an embodiment preparation process, which is performed by the system of FIG. 1.

FIG. 10 is a magnified view showing a code of the container of FIG. 8.

FIG. 11 is a side view showing an example container of the container of FIG. 8.

FIG. 12 is a plan view showing the container of FIG. 11.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a dosing member, e.g. a membrane, for dosing the container. The container may have various forms, including one or more of frustoconical; cylindrical; disk; hemispherical; packet; other like form. The container may be formed from various materials, such as metal or plastic or a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to a change in a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material. The processing unit may have any suitable implementation, including a container processing unit or a loose material processing unit.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “loose material processing unit” may refer to an arrangement that can process loose material of a pre-precursor material to a precursor material. The loose material processing unit may be arranged to process the pre-precursor material by one of more of the following: heating; cooling; grinding; mixing; soaking; conditioning; other processing step. The loose material may be supplied to the loose material processing unit in a container, from which it is extracted and processed.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication Interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to storage medium that encodes preparation information. The code may be an optically readable code, e.g. a bar code. The code may be formed of a plurality of units, which can be referred to as elements or markers.

As used herein, the term “preparation Information” may refer to information related to a preparation process. Depending on the implementation of the processing unit said information may vary. The parameters that may be associated container processing unit that comprises a fluid processing system, can include one or more of: fluid pressure; fluid temperature; mass/volumetric flow rate; fluid volume; filtering/purification parameters for the fluid; carbonation parameters for the fluid. The parameters that may be associated container processing unit that comprises a loose material processing unit, can include one or more of: grinding parameters, including intensity; heating temperature. More general parameters can include one or more: container geometric parameters, e.g. shape or volume; the type of precursor; phase identifier, for when a preparation process is split into a series of phases, whereby each phase comprises a set of one or more of any of the aforesaid parameters; duration, including phase duration (e.g. a duration for applying the parameters of a phase or any of the aforementioned parameters generally; and a container identifier, which may for example be used to monitor container consumption for the purpose of container re-ordering or look-up of information from the server system; an expiry date, a recipe identifier, which may be used to lookup a recipe stored on the memory of the machine for use with the container.

### [General System Description]

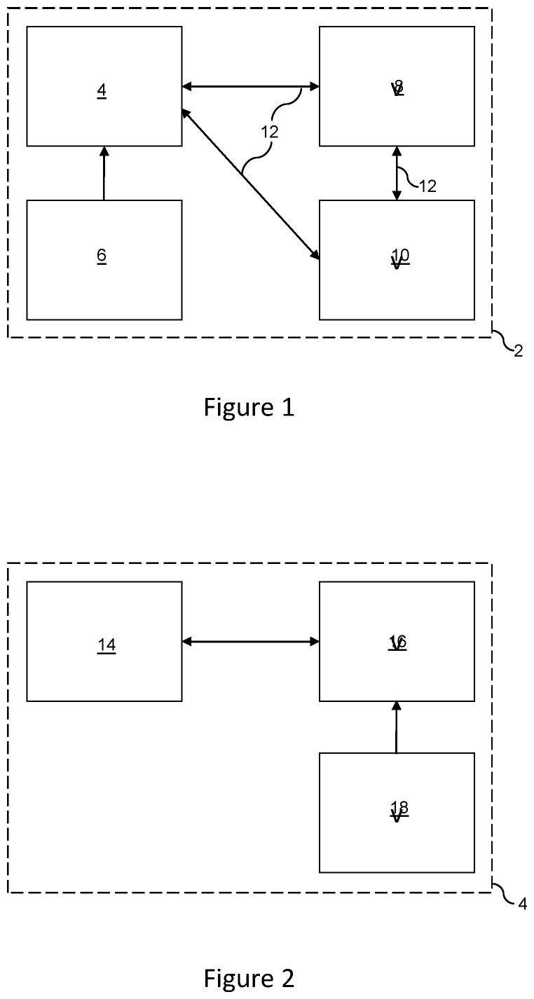

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### [First Example of Processing Unit]

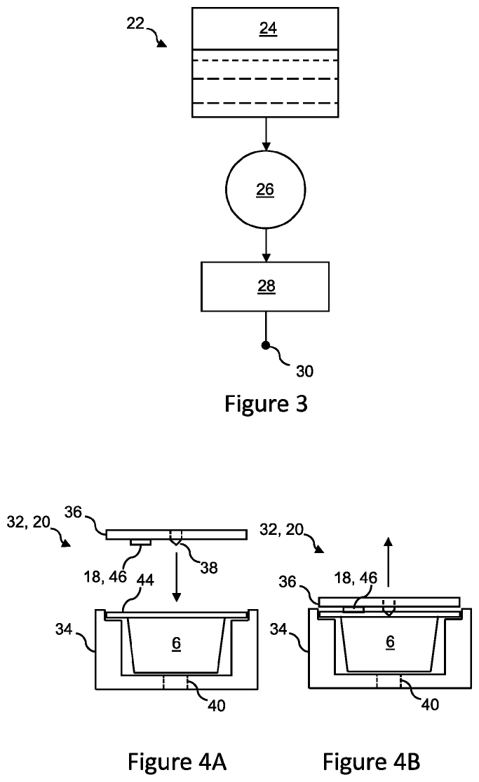

Referring to FIGS. 2 and 3, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### [Fluid Conditioning System]

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1-6 below:

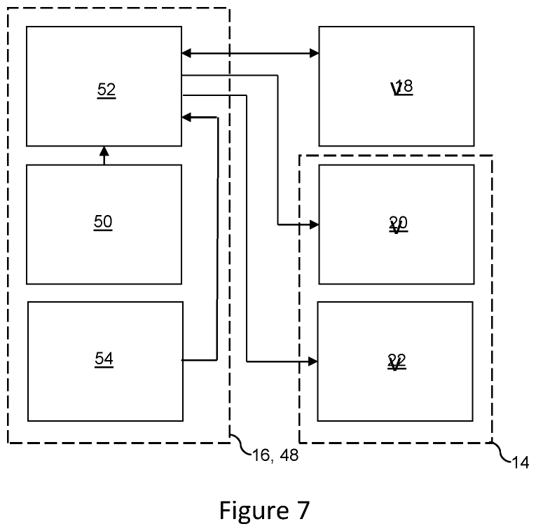

Referring to FIGS. 4A and 4B, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a dosing portion 36. The extraction unit 32 is movable to a capsule receiving position (FIG. 4A), in which capsule holding portion 34 and a dosing portion 36 are arrange to receive a capsule 6. The extraction unit 32 is movable to a capsule extraction position (FIG. 4B), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 to inject the conditioned fluid into the capsule 6 in the capsule extraction position, typically under high pressure. A beverage outlet 40 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIG. 4A, 4B) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the dosing portion and capsule holding portion, they may be alternatively arranged, including: the injection head and beverage outlet are arranged respectively on the capsule holding portion and dosing portion; or both on the same portion. Moreover, the extraction unit may include both parts arranged as a capsule holding portion, e.g. for capsules that are symmetrical about the flange, including a Nespresso® Professional capsule.

Examples of suitable extraction units are provided in EP 1472156 A1 and in EP 1784344 A1, which are incorporated herein by reference, and provide a hydraulically sealed extraction unit.

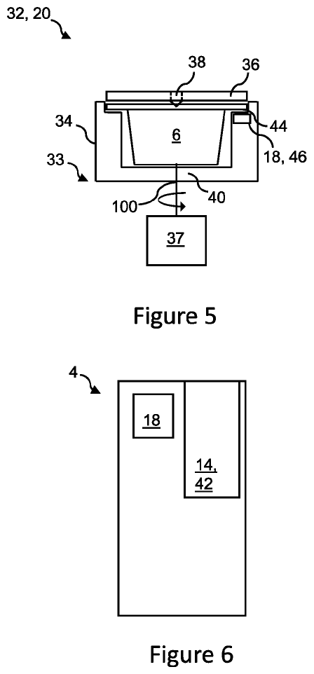

Referring to FIG. 5, in a second example of the container processing unit 20, the extraction unit 32 is as described for the first example, however the extraction unit 32 operates at a lower fluidic pressure and by centrifugation. In particular, the extraction unit 32 includes a rotation mechanism 33 that includes a capsule holing portion 34 to hold the capsule 6 and a drive system 37 to rotate said capsule holder 35.

The outlet 30 of the fluid conditioning system 22 is arranged as on the dosing portion 36 as an injection head 38 to inject the conditioned fluid into a centre of the capsule 6 through a dosing member of the capsule 6 as will be discussed. The rotation mechanism 33 rotates the capsule to effect transmission of the conditioned fluid radially outwards through precursor material in the capsule 6 and out through peripheral arranged puncture points (not illustrated) in the dosing member. An example of a suitable capsule is a Nespresso® Vertuo capsule. A suitable example is provided in EP 2594171 A1, which is incorporated herein by reference.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a containment portion of the capsule. An example of a suitable capsule is a Nespresso® Dolce Gusto capsule. Examples of suitable extraction units are disclosed in EP 1472156 A1 and in EP 1784344 A1, which are incorporated herein by reference.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle.

### [Second Example of Processing Unit]

Referring to FIG. 6, in a second example of the processing unit 14, said unit comprises a comprises a loose material processing unit 42.

The loose material processing unit 42 is arranged to receive loose pre-precursor material from a container 6 and to process the pre-precursor material to derive the precursor material. The electrical circuitry 16 uses the preparation information read from the container 6 to control the loose material processing unit 42 to execute the preparation process.

A user presents manually the container 6 to a code reading system 18, of the machine 4, to read the code. The user then opens the container 6 and dispenses the pre-precursor material (not illustrated) arranged therein into the loose material processing unit 42. The loose material processing unit 42 processes the loose pre-precursor material to the precursor material.

In a particular example, the pre-precursor material is coffee beans, and the loose material processing unit 42 is arranged to roast and/or grind the coffee beans to provide a precursor material.

In variant embodiments, which are not illustrated, the loose material processing unit is alternatively configured, including: with a dispensing system to open and dispense the pre-precursor from the capsule for subsequent processing (e.g. it may include a cutting tool to cut open the container and an extractor such as a scope to extract the pre-precursor material); the pre-precursor material may be processed in the container and either dispensed from the container by the aforedescribed example or provided to a user in the container.

### [Code Reading System]

Referring to FIGS. 4A and 4B, the code reading system 18 is arranged to read a code 44 arranged on a closing member of the container 6. The code reading system 18 is integrated with the extraction unit 32 of first example of the container processing unit 20. The code 4 is read with the extraction unit 32 in the capsule extraction position (as shown in FIG. 4B).

The code reading system 18 includes an image capturing unit 46 to capture a digital image of the code U. Examples of a suitable image capturing unit 46 include a Sonix SN9S102; Snap Sensor S2 imager; an oversampled binary image sensor; other like system.

The electrical circuitry 16 includes image processing circuitry (not illustrated) to identify the code in the digital image and extract preparation information. An example of the image processing circuitry is a Texas Instruments TMS320C5517 processor running a code processing program.

Referring to FIG. 5, the code reading system 18 is arranged to read a code 4 from an underside of a flange of the container 6. The code U is read based on rotation of the code 4 relative a code reader 46 of the code reading system 18. The code 4 is read with the extraction unit 32 in the capsule extraction position (as shown in FIG. 5), with the rotation mechanism 33 rotating the container 6.

The code reading system 18 includes a code reader 46 to capture a code signal of the code 44. Examples of a suitable image code reader 46 include a photo diode or other electrical componentry that can distinguish between dark an light elements of the code. In variant embodiments, which are not illustrated, the code reader can be implemented as the image capturing unit, as discussed above, or with another suitable reading system.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is alternatively implemented, e.g. the code reading system is arranged on the machine to read a code of a container that a user manually presents to the image capturing device. In further variant embodiments, which are not illustrated, the code reading system is arranged to read a code at a different location of the container, e.g. on a storage portion.

### [Control Electrical Circuitry]

Referring to FIG. 7, the electrical circuitry 16 is implemented as control electrical circuitry 48 to control the processing unit 14 to execute a preparation process. In the embodiment of FIG. 7, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 46 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule; for the loose material processing unit the feedback system may be used to implement control of grinding rate and/or a heating temperature.

### [Container]

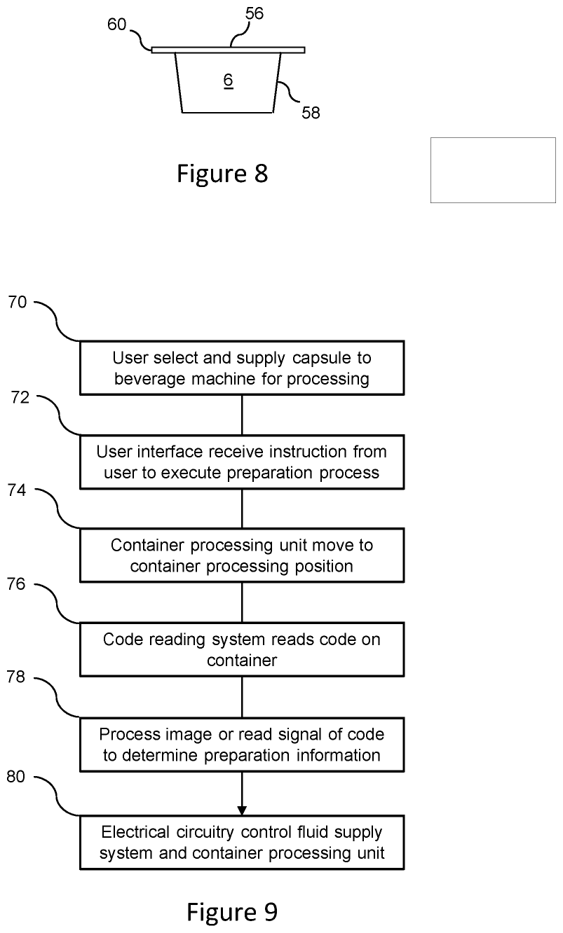

Referring to FIG. 8, an example of a container 6, that is for use with the first example or second example of the processing unit 14 comprises the container 6 arranged as a capsule. The capsule includes: a dosing member 56; a storage portion 58, and; a flange portion 60.

The storage portion 58 includes a cavity for storage of the precursor material (not illustrated). The dosing member 56 closes the storage portion 58 and comprises a flexible membrane. The flange portion 60 is arranged integrally with the storage portion 58 and presents a flat surface for connecting the dosing member 56 to the storage portion 58 to hermetically seal the precursor material. The capsule 6 has a diameter of 2-5 cm and an axial length of 2-4 cm.

In variant embodiments, which are not illustrated, the container can have various shapes including: hemispherical; curved; rectangular in section; frustoconical, and; other like shapes. The dosing member may be arranged as a rigid member, rather than a membrane. The container may be formed of two similar or identical storage portions that are connected at a flange, hence the dosing member can me omitted. The flange may be connected to the storage portion, hence as separate components. The dosing member may connect to the storage portion, hence the flange may be omitted.

Suitable examples of containers and/or dosing members in terms of shapes, dimensions and/or materials are know from any of the cartridges, capsules and pods for portioned flavouring ingredients used by Nespresso™ (Original Line, Professional Line, Vertuo Line) and Nestle Dolce Gusto™ and Nestle Special-T™. The materials may thus include metal, for instance aluminium, plastic and/or paper. The materials are preferably biodegradable and/or recyclable. Suitable use, e.g. extraction, processes and systems are also known from Nespresso™, Nestle Dolce Gusto™ or Nestle Special-T™.

Constructional, manufacturing and/or (beverage) extraction details of containers and/or dosing members are for instance disclosed in EP 2155021, EP 2316310, EP 2152608, EP2378932, EP2470053, EP2509473, EP2667757 and EP 2528485.

### [Arrangement of Code]

Referring to FIG. 8, the code 4 code is arranged on an exterior surface of the container 6 in any suitable position such that it can be read by the code reading system 18.

Referring to FIG. 8, the code 4 (not illustrated in FIG. 8) may be arranged on one or more of the following positions: the dosing member 56; a lower surface of the flange portion 60 that faces away from the dosing member 56; the storage portion 58.

### [Preparation Process]

Referring to FIG. 9, the execution of a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first or second example of the container processing unit 20, the extraction unit 32 is moved from the capsule receiving position (FIG. 4A) to the capsule extraction position (FIG. 4B, FIG. 5)).

Block 76: the electrical circuitry 16 controls the code reading system 18 to read the code 4 on the container 6 and provide a digital image of the code or an code signal related to the code.

Block 78: the code processing circuitry of the electrical circuitry 16 processes the digital image to or code signal extract the preparation information.

Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction position though the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted; alternatively at blocks 70 to 76 a user presents the code of the container to the code reading system and after it is read opens said container and dispenses the pre-precursor material into the processing unit. Moreover, the container processing unit may be manually moved between the extraction position and capsule receiving position.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### [Code General Description]

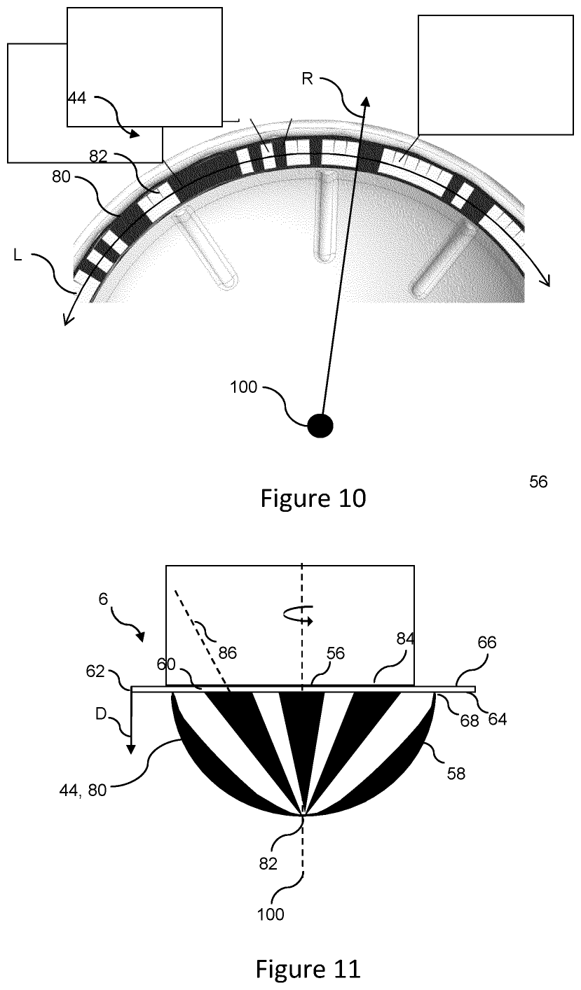

Referring to FIG. 10, the code 4 is formed of a plurality of elements 80. The elements 80 are arranged on a surround 82. The elements 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween. In variant embodiments, which are not illustrated: the elements are a light colour and the surround is a dark colour.

The elements 80 are formed by printing e.g. by means of an ink printer. As an example of printing the ink may be conventional printer ink and the substrate may be the container outer surface including one of the dosing member, flange or storage portion, or a separate substrate, which is connected to the container. In variant embodiments, which are not illustrated, the elements are alternatively formed, including by embossing, engraving or other suitable means.

The elements 80 have various shapes as will be discussed. As used herein the term “shape” in respect of the elements may refer to an exact shape or an approximation of the actual shape, which can occur to a printing or other manufacturing variations in precision.

The elements 80 are arranged to be read sequentially when the container is rotated about an axis of rotation 100 (as also illustrated in FIG. 5). The elements 80 of the code 44 are arranged on a circumferentially extending virtual line L.

### [Code Encoding]

The elements 80 encode a data portion for storing the preparation information, and encode a finder sequence for locating the data portion. The elements 80 are encoded as a bit code, wherein the absence or presence of an element encodes a logical 1 or a 0.

The finder sequence (not illustrate) comprises a predefined reserved sequence of logical 1s and/or 0s, which is identifiable when processing the code. The data sequence is arranged at a known position with respect to the finder sequence, e.g. immediately after or distributed within the finder sequence. Hence with the finder sequence located, the data sequence can then be located read and decoded. The data sequence may be decoded based on a rule stored on the electrical circuitry 16 (e.g. via electronic memory) of the machine 2. A specific example of such a code is provide in EP 2594171 A1.

### [Code Arrangement]

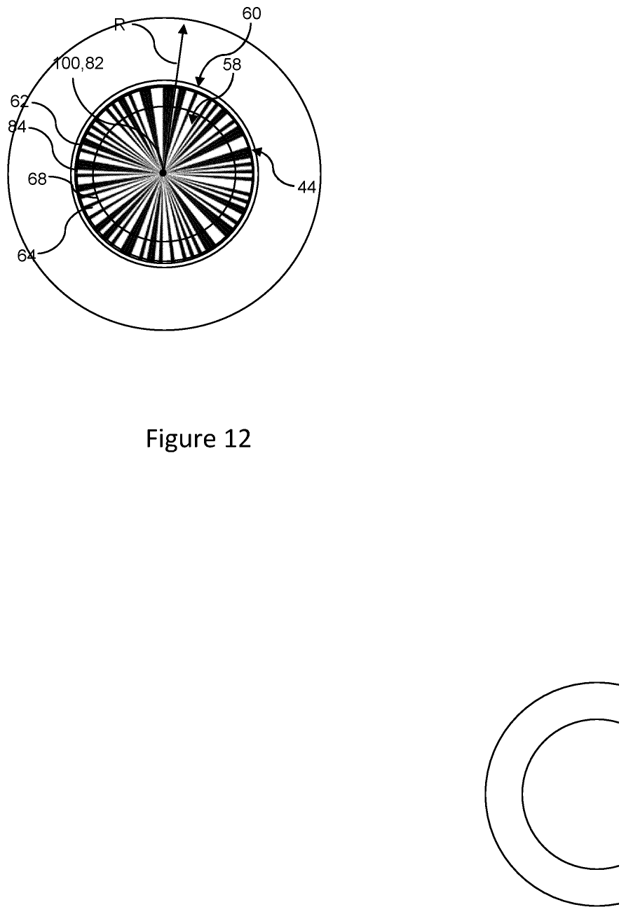

Referring to FIGS. 11 and 12, which is a more detailed example that implements the features discussed in association with the embodiments of FIGS. 8 and 10. The each element 80 of the code 44 extends from a first position 82 a second position 84, which span a substantial portion of the storage portion 58 and flange 60. The first position 82 is arranged on the storage portion 58. The second position 84 is arranged on the flange 60. In this way the code 44 can be read from a range of positions both on the storage portion 58 and the flange 60.

The elements 80 converge to the axis of rotation 100 of the container 6. In this way the code 44 can be read from any position between the first position 82 and the second position 84 as the container is rotated about the axis 100. The first position 82 is at the axis of rotation 100. The second position is at junction of an outer rim 62 and a lower surface 64 of the flange 60 (an upper surfaces 66 of the flange 60 is defined as the surface over which the membrane 56 extends). Hence the elements 80 extend across the entire storage portion 58 to an interior edge 68 of the flange 60 that adjoins the storage portion 58 and over the entire lower surface 64 of the flange 60.

The elements 80 are arranged with a centreline 86 through the circumferentially extending section of the elements aligned to a radial direction R. The elements 80 extend with increasing circumferential distance with radial distance such that they occupy the same circumferential portion of the whole circumference independent of radial distance. The elements 80 extend continuously, e.g. not in discrete separate portions, between the first position 82 and the second position 84. In this way the code can be read equivalently at any position between the first and second positions.

In variant amendments, the elements of the code can be alternatively arranged including: with the centre lines not aligned to the radial direction, e.g. they may be arranged forward and/or be arranged behind the radially line including as a swirl; the outer rim of the flange may also include the code; the first position can be arranged proximal to rather than at the axis of rotation, including at a base region of the storage portion; and the elements may extend as a series of discrete positions between the first and second position.

A “base region” of the storage portion can be defined as a region that includes the base (i.e. a lowest point) of a cavity of the storage portion 58. It may also include a region of depth D greater than 70% or 80% or 90% of the maximum depth, wherein the maximum depth is at the lowest point of the cavity and the depth direction extends from the flange.

In variant embodiments, which are not illustrated: the first position and second position are both arranged on the storage portion (e.g. and not on the flange) such that the code can be read at a range of positions on the storage portion. In particular, the first position can be arranged at the axis or rotation or more generally at a base region as defined above. The second position can be arranged at or proximal the inner edge of the flange that adjoins the storage portion.

A method of encoding preparation information with the code 4 comprises: arranging elements 80 of the code 4 to extend from the first position 82 to the second position 84, wherein the first position is arrange on the storage portion and the second portion is arranged on the storage portion 58 or flange 60. A method of reading the code 4 comprises reading the code at any position between the first position 82 and second position 84, hence the code 4 is compatible with a range of machines 4, wherein a code reading system 18 can have a range of orientations.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particulary the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

LIST OF REFERENCES

2 System
4 Machine
14 Processing unit
20 Container processing unit (first/second example)
32 Extraction unit
34 Capsule holding portion
36 Closing portion
38 Injection head
40 Beverage outlet
33 Rotation mechanism
37 Drive system
22 Fluid conditioning system
24 Reservoir
26 Pump
28 Heat exchanger
30 Outlet
42 Loose material processing unit
16 Electrical circuitry
48 Control electrical circuitry
50 Input unit
52 Processor
54 Feedback system
18 Code reading system
46 Image capturing unit
6 Container (Capsule)
56 Closing member (membrane)
64 Lower surface
66 Upper surface
58 Storage portion
60 Flange portion
62 Rim
64 Lower surface
66 Upper surface
68 Inner edge
44 Code
80 Elements
82 First position
84 Second position
86 Centre line
L Virtual line
82 Surround
100 Axis
R Radial direction
8 Server system
10 Peripheral device
12 Computer network

1. A container arranged for containing a precursor material for use with a machine for preparing a beverage and/or foodstuff, the container comprising:
a storage portion
a closing member,
a flange connecting the storage portion and closing member, and
a machine-readable code storing preparation information for use with a preparation process performed by said machine, the code comprising a plurality of elements:
the elements of the code extend from a first position on the storage portion to a second position on the flange, so that the code is readable from the flange or the storage portion, the elements arranged to be read about an axis of rotation of the container.

2. The container of claim 1, wherein the container is rotationally symmetric about an axis of rotation and the code is arranged along a virtual circular line that has a center at the axis of rotation.

3. The container of claim 1, wherein the first position is at a base region of a cavity of the storage portion.

4. The container of claim 1, wherein the first position is at an axis of rotation of the container.

5. The container of claim 1, wherein the second position is proximal or at an outer rim of the flange.

6. The container of claim 1, wherein the code elements extend with a linear centre line aligned to the radial direction from the first position to the second position.

7. The container of claim 6, wherein the code elements extend with increasing circumferential width with radial distance, such that so their relative circumferential proportion does not change with radial distance.

8. The container of claim 1, wherein the code elements extend continuously between the first and second positions.

9. A container arranged for containing a precursor material for use with a machine for preparing a beverage and/or foodstuff, the container comprising:
a storage portion,
a closing member,
a flange connecting the storage portion and closing member, and
a machine-readable code storing preparation information for use with a preparation process performed by said machine, the code comprising a plurality of elements:
wherein said elements of the code extend on the storage portion from a first position to a second position,
the first position at a centre of a base region of the storage portion the second position at a junction of the storage portion and the flange, the elements arranged to be read about an axis of rotation of the container.

10-13. (canceled)

14. A method of encoding preparation information with a code, the method comprising:
arranging elements of the code to extend from a first position on a storage portion of a container to a second position on a flange of the container, so that the code is readable from the flange or the storage portion, the elements arranged to be read about an axis of rotation of the container.

15. (canceled)
